(19) United States
(12) Patent Application Publication
(10) Pub. No.: US 2014/0058758 A1
(43) Pub. Date: Feb. 27, 2014

(54) Interaction With Parties For Workers Compensation

(71) Applicant: CompMinder LLC, (US)

(72) Inventors: Robert F. Hollingsworth, Draper, UT (US); Robert W. Leckie, Draper, UT (US)

(73) Assignee: CompMinder LLC, Draper, UT (US)

(21) Appl. No.: 13/770,960

(22) Filed: Feb. 19, 2013

Related U.S. Application Data
(60) Provisional application No. 61/599,864, filed on Feb. 16, 2012.

(51) Int. Cl. G06Q 40/08

(52) U.S. Cl. CPC G06Q 40/08
USPC 705/4

(57) ABSTRACT

Technology is described for interacting with employers in a worker's compensation process. The method can include receiving a worker's compensation claim at a server. The worker's compensation claim can be stored in a database and submitted to a worker's compensation carrier. An employee update request can be sent to an insured employer in a short range time frame. An employer claim update request can be sent to the insured employer in a medium range time frame, and a decision time update request can be sent to the insured employer in a medium range time frame. In addition, a weekly follow-up reminder request may be sent to the insured employer until the employee is back to work with no restrictions.

### CLAIM OF PRIORITY

Priority to U.S. Provisional patent application Ser. No. 61/599,864 filed on Feb. 16, 2012 is claimed.

### BACKGROUND

Workers' compensation can provide wage replacement and medical benefits to employees injured during their employment in exchange for mandatory relinquishment of the employee's right to sue the employer in a legal court for negligence. The tradeoff between assured, limited coverage and lack of recourse using the worker compensation system is a bargain made by the worker to obtain more immediate compensation.

Plans in varying jurisdictions can provide weekly payments in place of wages, compensation for past and future economic loss, reimbursement or payment of medical and similar expenses, and benefits payable to the dependents of workers killed during employment. General damages for pain and suffering and punitive damages for employer negligence are generally not available in workers' compensation plans.

Before the statutory establishment of workers' compensation, employees who were injured on the job were only able to pursue their employer through civil or tort law. Although employers' liability was unlimited, courts usually ruled in favor of employers, paying little attention to the full losses experienced by workers, including medical costs, lost wages, and the loss of future earning capacity.

Statutory compensation law provides advantages to employees and employers. A schedule is drawn out to state the amount and forms of compensation to which an employee is entitled based on the employee's injuries. Statutes often award a set amount based on the types of injury.

### BRIEF DESCRIPTION OF THE DRAWINGS

FIG. 1 is a block diagram illustrating an example of relationships between the parties involved in worker's compensation insurance.

FIG. 2 is an example of a flowchart illustrating a method for interacting with parties in a worker's compensation process.

FIG. 3 is a block diagram illustrating an example of a method for communicating with parties in the worker's compensation process.

FIG. 4 is a block diagram illustrating another example of a system for communicating with parties in the worker's compensation process.

FIG. 5 is block diagram illustrating an example of servers that can contain multiple web applications and databases and a mobile computing device with a camera is also illustrated.

FIG. 6 is a block diagram illustrating an example of a computing device that may be used to execute an electronic interaction with parties in a worker's compensation process.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

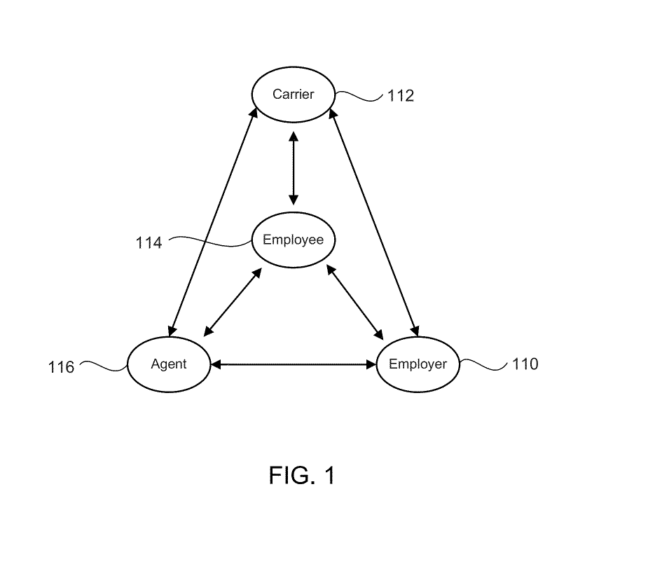

FIG. 1 illustrates example relationships between the parties involved in worker's compensation insurance. In order to file a worker's compensation claim, an employer 110 submits a worker's compensation claim to a worker's compensation carrier 112 that is providing worker's compensation insurance coverage. Once this claim has been filed, then the carrier can work with the employee or worker 114 to determine how much the employee may get paid for their injuries and related problems. These payments are determined using pre-defined schedules set by statute or other governmental regulation. During this process, the worker's compensation agent 116 who originally setup and maintains the worker's compensation package between the carrier and employer may not even be notified of the claim.

In this system, the employer does not generally have an effective communication channel with the carrier after the claim has been filed to aid in determining what the employee should be paid. While the employer may contact the carrier via phone, this can take a significant amount of time and there may be difficulty in communicating with the busy claim adjusters of the carrier. In addition, the employer may not even know what information may be helpful to the carrier in processing the worker's compensation claim. Typically, the carrier will communicate with the employee directly but the employer is not likely to follow-up on the claim. In addition, there is generally no communication between the health care professionals or doctors who are treating the injured employee and the employer. In fact, a claims adjuster who is working for the worker's compensation carrier may be handling up to 200 or more cases at a time. This type of case load does not leave the claims adjuster with the time or ability to proactively contact an employer.

Often, once the employer hears back from the employee and finds out that the employee is healing well, then the employee is ready to return back to work and the worker's compensation money calculated by the carrier has already been paid to the employee. This lack of employer or agent involvement in the process can result in the employer paying 20-50% more money to the employee than would otherwise be paid under the existing legal guidelines, as compared to the situation where the worker's compensation carrier had more information about the worker's ability to work, the worker's medical status, and other related worker's compensation claim information.

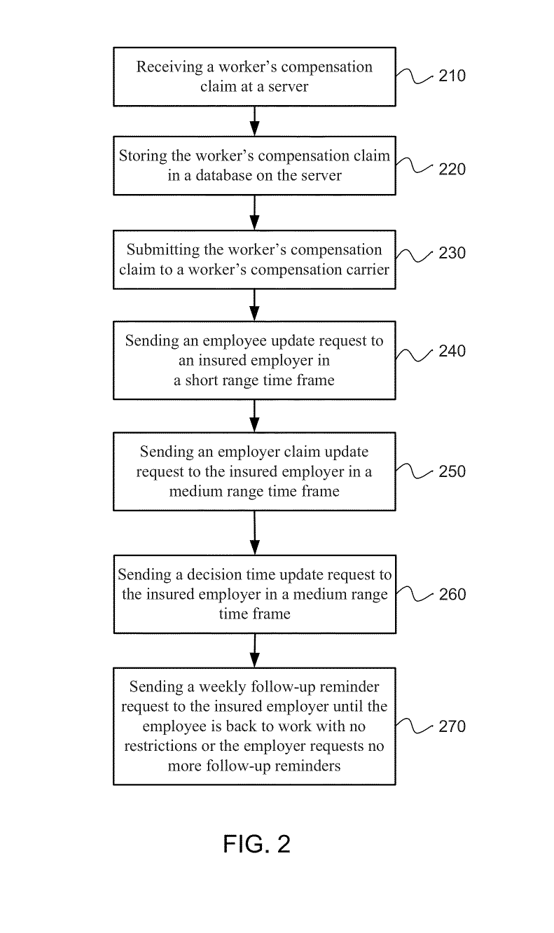

FIG. 2 illustrates a method for interacting with employers, agents and carriers in a worker's compensation process. The method can include the operation of receiving a worker's compensation claim at a server, as in block 210. The worker's compensation claim can be received over the internet from an employer using a client computer having a web browser. For example, the worker's compensation claim can be submitted using a web form via a web application. Alternatively, the worker's compensation claim can be submitted over the internet using a PDF (Portable Document Exchange) document, EDI (Electronic Document Exchange) format, or one of a large number of other electronic document formats. The server can also include a processor and a memory. The worker's compensation claim can be stored in a database on the server, as in block 220. The database may be a relational database, object oriented database, a flat file database, or another existing database type.

A further operation can be submitting the worker's compensation claim from the server to a worker's compensation carrier, as in block 230. This submission starts the process of communication between the carrier and the injured employee to allow the injured employee to be compensated for time lost from the job, medical expenses, and other items covered by the worker's compensation policy. The employer may also receive an immediate electronic confirmation through their web browser or another messaging system that the worker's compensation claim was received.

Another separate message can be sent to a worker's compensation agent, insured employer, and/or the injured employee when the worker's compensation claim is activated with the worker's compensation carrier. This message can include an electronic copy of the official worker's compensation claim as submitted to the carrier. This copy may be in .PDF (Portable Document) format, EDI (electronic data interchange) format, or another electronic document format.

The technology can send an employee update request to an insured employer in a short range time frame after the worker's compensation claim has been submitted, as in block 240. The employee update request can be sent by the server using an email or instant messaging module on the server. The short range time frame can be defined as an update request that is sent in less than 12 hours. For example, the employee update request can be sent in a short range time frame of less than 4 hours after the worker's compensation claim is submitted. The employee update request can include a request for the employer to follow-up and contact the employee about the employee's injury condition. In addition, the employee update request can ask the employer to find out about the employees well-being. This initial contact is useful because the contact initiates a communication channel with the employee.

An employer claim update request can be sent to the insured employer in a medium range time frame after the worker's compensation claim has been submitted, as in block 250. The medium range time frame can be an update request that is sent out in less than 72 hours and more than 12 hours after the worker's compensation claim has been submitted. For example, the employer update request can be sent out 24 hours after the worker's compensation claim is submitted. The employer claim update request can include a request to collect information using a web application or another electronic collection channel. The information requested may include information about: whether the employee has returned to work, work type currently performed by the employee (e.g. light duty or released work), whether a doctor has been contacted if the employee has not returned to work, and whether there is a reason for insurance agent contact.

A decision time update request can be sent to the insured employer in a medium range time frame after the worker's compensation claim is submitted, as in block 260. The decision time update request can include a request to find out about: whether the employee has returned to work, why the employee has not returned to work, who contacted the doctor, an estimated date for return to work, and a reason to contact the agent.

Later, a weekly follow-up reminder request or update request can be sent to the insured employer until the employee is back to work with no restrictions or the employer requests no more follow-up reminders, as in block 270. The weekly reminder request can include a request to collect information about: the employee's medical treatment, the employee's medical condition, who contacted the doctor if the employee has not returned to work, and any reason to contact the agent.

Once an employee has returned to work, the system may send the insured employer a bi-monthly update request until a claim is closed or the claim reserves have been removed. This update request message can let the employer know that issues are still outstanding on the claim and what those issues may be. In addition, an employer may also unsubscribe themselves from receiving this type of email at any time. The update requests described with this technology can be sent via email, instant message, text message, telephone, fax, on-line reminder, web application reminder, or another electronic communication method using a computer network. Alternatively, the employer may ask that the bi-monthly reminders be replaced with a request for a later reminder at a date determined by the employer (e.g. 6 months later a reminder may be sent). The employer may receive bi-monthly updates after that later reminder or receive no further reminders after that later reminder.

The update request messages sent to the employer may also have an expiration time within which the employer is expected to respond. This expiration time may be represented as a deadline in the email, instant message, text message, or other message received by the employer. Alternatively, a countdown clock can be provided in the web application showing the time remaining to respond to specific update requests. If the employer does not respond to the messages, then further messages can be sent to a supervisor noting the failure to respond and explaining the expected financial loss associated with the failure to respond.

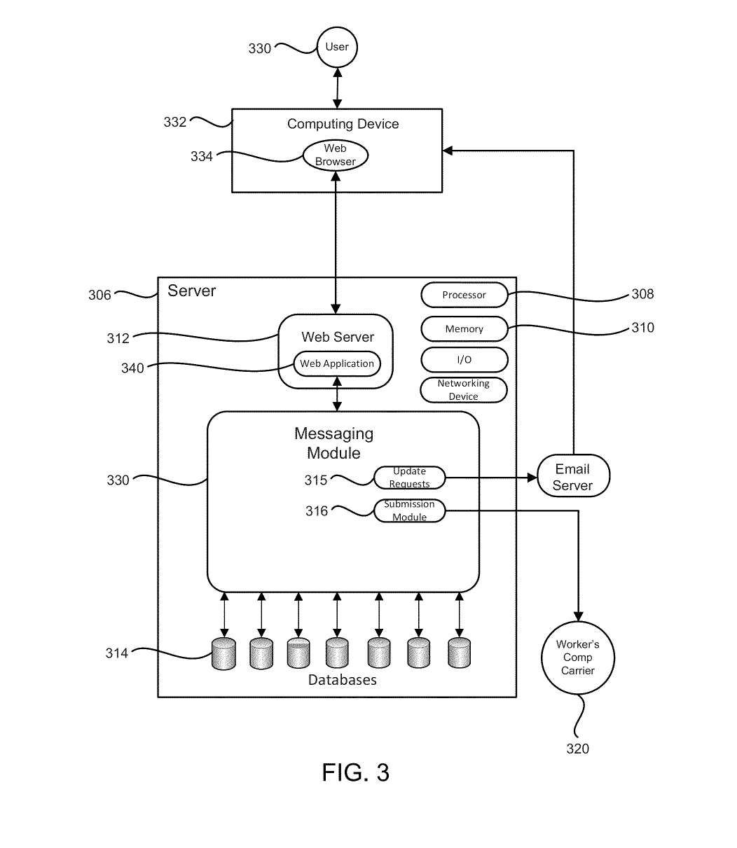

FIG. 3 illustrates an example system for communicating with parties in the worker's compensation process. The system can include a server 306 having a processor 308 and a memory 310. The memory can be any type of RAM (Random Access Memory), DRAM (Dynamic Random-Access Memory), or similar memory used by a server.

A web server 312 can be located on the server to initially receive a worker's compensation claim from a user 350 as sent via a web browser 334. The user may use a computing device 332 with a web browser 334 to submit the claim. Alternatively, a custom application client can be used by the user to submit the claim. A database 314 can also be located on the server to store the worker's compensation claim. Alternatively, the database can be located on a separate database server in communication with the first server.

A submission module 316 in a messaging module 330 can be used to receive submissions of the worker's compensation claims for a worker's compensation carrier 320. The submission module can also notify a worker's compensation agent and employer when the worker's compensation claim is submitted to a worker's compensation carrier.

A messaging module 330 can also be located in the server to send update requests 315. The update requests may include: 1) an employee update request to the insured employer less in a short range time frame after the worker's compensation claim has been submitted, 2) an employer claim update request to the insured employer in a medium range time frame after the worker's compensation claim has been submitted, 3) an employer claim update request to the insured employer in a medium range time frame after the worker's compensation claim has been submitted, and/or 4) a decision time update request to the insured employer in a medium range time frame after the worker's compensation claim is submitted. The messaging module can also configured to send a weekly follow-up reminder request to the insured employer until the employee is back to work with no restrictions, as discussed before.

A web application 340 on the web server can be used to collect information for the messaging module. The web application can also control the messaging module and control when the messages are sent out for update requests.

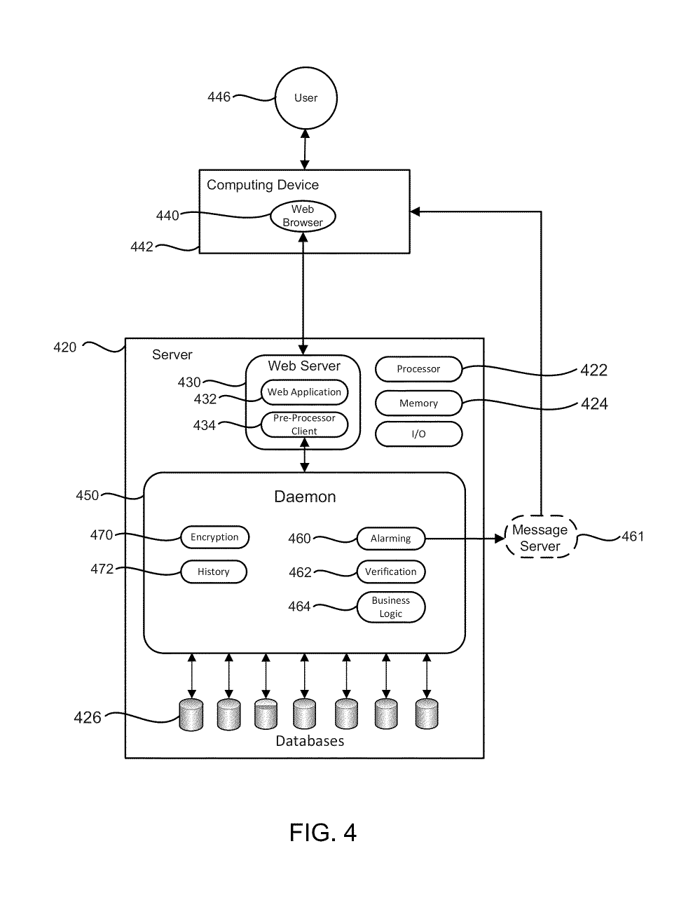

FIG. 4 illustrates another example of a system for communicating with parties in the worker's compensation process. The system can include a server 420 having a processor 422 and a memory 424. A plurality of databases 426 can be located on the server to store the worker's compensation claims that are received.

A web server 430 on the server 420 can receive a worker's compensation claim using a web application 432 or another electronic receiving channel on the web server. The web application pages can be processed using a pre-processor 434 as the web pages are retrieved from the database and translated to HTML and similar internet protocols that are viewable on a web browser 440 on computing device 442 accessed by an end user 446. The computing device may be a desktop or laptop computer. Alternatively, the computer device may be a mobile computing device such as a cell phone, mobile tablet, or another mobile computing device.

A daemon 450 on the web server can receive requests for web pages from the web application via the web server and retrieve web pages from the database. The database pages can be store directly in the database to allow for easier processing by the daemon. The daemon is a process that is running on the web server to fulfill web application requests for web pages or application pages from the database and application data from the database. The daemon also provides expanded functionality for the databases and web pages.

An alarming module 460 can be located in the daemon that checks the age of worker's compensation claims in the database to determine when update requests for updated worker's compensation claim information may be sent out. More specifically, the alarming module in the server can send requests to the employer or others at predefined intervals to collect information from the employer using web pages and forms.

These alarm requests can be sent via email, instant messaging, SMS text message or any other form of electronic messaging. For example, when the requests are email messages, the email can contain a URL (Uniform Resource Locator) link to a web form request of a web application. The messages may be sent using a message server 461 or the daemon can act as a messaging server.

The update requests can contain a request for information selected from the following types of requests: i) an employee update request to the insured employer, ii) an employer claim update request to the insured employer, iii) an employer claim update request to the insured employer, or iv) a decision time update request to the insured employer. The web application on the web server can distribute the web forms and collect information for update requests. Other types of requests related to the worker's compensation claim can also be made at desired times.

The daemon can contain an encryption module 470 to encrypt information being stored in the database. The encryption helps protect the sensitive medical history information and personal information in the database. A history module 472 can store every change to data in the database and include an identifier showing the individual who made the change. A verification module 462 can verify security access to data in the database(s) 426 as requests are made by the web application 432. These security services can be provided for each web page accessed from the database by the web server. A business logic module 464 can also be provided to trigger code related to a database field and provide additional functionality for selected data fields or columns in the database.

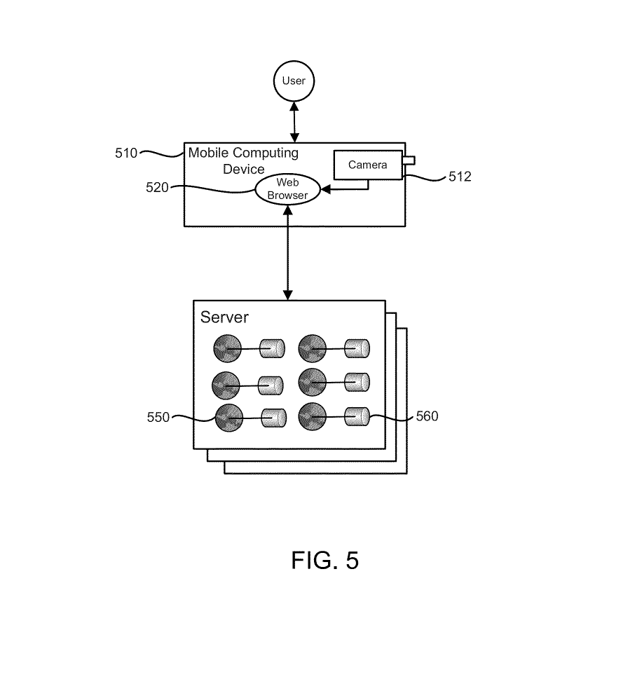

FIG. 5 illustrates that each server can contain multiple web applications 550 and web databases 560. The web application(s) and/or databases can be separate for each employer in the worker's compensation system. This provides a level of security to thwart a hacker who breaks into one employer's database, because the hacker will not be able access the sensitive information of other employers because each employer's information can be housed in a separate database. This modular configuration is useful because employers desire to protect the sensitive medical and personal information for the employees and company.

The method described using FIG. 2 can also be used in an extended configuration. The web application can be accessed using a mobile computing device 510 (FIG. 5). The first step in starting a worker's compensation claim can be capturing an image on a mobile computing device related to a worker's compensation claim. FIG. 5 illustrates a camera 512 that is in communication with the web application 550 through a web browser 520. The mobile computing device can be a cellular phone, tablet device, a laptop or another mobile computing device.

The worker's compensation claim can then be started on a mobile device in response to capturing the image of at the worker's compensation event. The worker's compensation claim associated with the image can be received at a worker's compensation carrier's server and stored in a database on the server, as described previously. Later the update requests may be sent to the employer. These requests can include an employee update request, an employer claim update request, a decision time update request, and a weekly follow-up reminder request as defined previously. In this configuration, each claim may be associated with a photo of the event, a photo of the injury location, or injury itself. This is helpful because the claim is started immediately when the picture is taken. The picture also aids in determining the severity of the claims. Further, the picture can initially verify the authenticity of the claim for the claim adjuster.

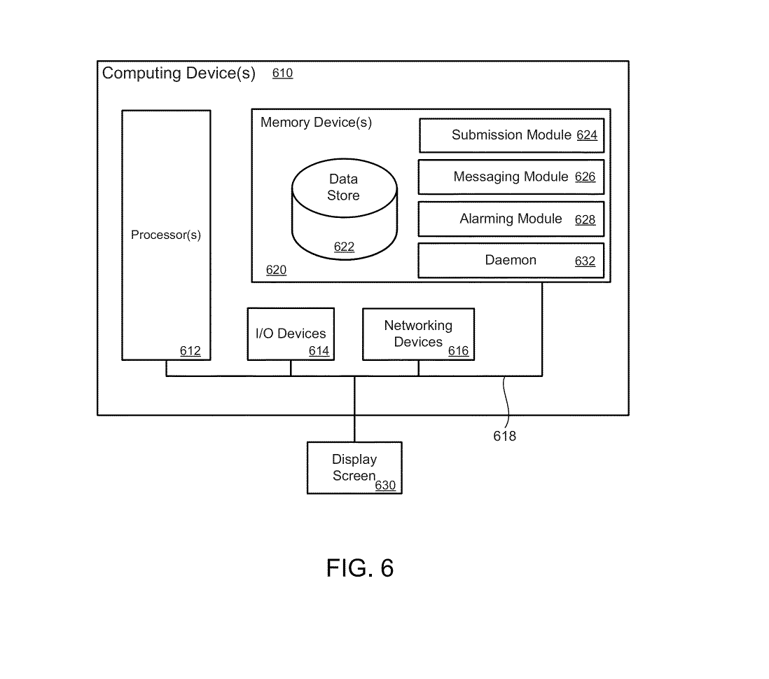

FIG. 6 illustrates a computing device 610 on which modules of this technology may execute. A computing device 610 is illustrated on which a high level example of the technology may be executed. The computing device 610 may include one or more processors 612 that are in communication with memory devices 620. The computing device may include a local communication interface 618 for the components in the computing device. For example, the local communication interface may be a local data bus and/or any related address or control busses as may be desired. The memory device 620 may contain modules that are executable by the processor(s) 612 and data for the modules. Located in the memory device 620 are modules executable by the processor. For example, the submission module 624, the messaging module 626, the alarming module 628, a daemon 628, and other modules may be located in the memory device 620. The modules may execute the functions described earlier. A data store 622 may also be located in the memory device 620 for storing data related to the modules and other applications along with an operating system that is executable by the processor(s) 612.

The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

Other applications may also be stored in the memory device 620 and may be executable by the processor(s) 612. Components or modules discussed in this description that may be implemented in the form of software using high programming level languages that are compiled, interpreted or executed using a hybrid of the methods.

The computing device may also have access to I/O (input/output) devices 614 that are usable by the computing devices. An example of an I/O device is a display screen 630 that is available to display output from the computing devices. Other known I/O device may be used with the computing device as desired. Networking devices 616 and similar communication devices may be included in the computing device. The networking devices 616 may be wired or wireless networking devices that connect to the internet, a LAN, WAN, or other computing network.

The components or modules that are shown as being stored in the memory device 620 may be executed by the processor 612. The term “executable” may mean a program file that is in a form that may be executed by a processor 612. For example, a program in a higher level language may be compiled into machine code in a format that may be loaded into a random access portion of the memory device 620 and executed by the processor 612, or source code may be loaded by another executable program and interpreted to generate instructions in a random access portion of the memory to be executed by a processor. The executable program may be stored in any portion or component of the memory device 620. For example, the memory device 620 may be random access memory (RAM), read only memory (ROM), flash memory, a solid state drive, memory card, a hard drive, optical disk, floppy disk, magnetic tape, or any other memory components.

The processor 612 may represent multiple processors and the memory 620 may represent multiple memory units that operate in parallel to the processing circuits. This may provide parallel processing channels for the processes and data in the system. The local interface 918 may be used as a network to facilitate communication between any of the multiple processors and multiple memories. The local interface 618 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled or described as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for interacting with parties in a worker's compensation process, comprising:
under control of a processor and memory configured with executable instructions,
storing a worker's compensation claim received from an employer in a database on a server having a processor and a memory;
submitting the worker's compensation claim from the server to a worker's compensation carrier; and
sending periodic update requests to an insured employer after the worker's compensation claim has been submitted.

2. The method as in claim 1, further comprising collecting the update requests by providing a URL link to a web form in a web application to enable update request information to be submitted to the database with the worker's compensation claim.

3. The method as in claim 1, wherein the periodic requests are sent to the employer in a short range time frame, medium range time frame, and weekly time frame.

4. A method for interacting with parties in a worker's compensation process, comprising:
under control of a processor and memory configured with executable instructions,
receiving a worker's compensation claim at a server having a processor and a memory;
storing the worker's compensation claim in a database on the server;
submitting the worker's compensation claim from the server to a worker's compensation carrier;
sending an employee update request to an insured employer in a short range time frame after the worker's compensation claim has been submitted; and
sending an employer claim update request to the insured employer in a medium range time frame after the worker's compensation claim has been submitted;
sending a decision time update request to the insured employer in a medium range time frame after the worker's compensation claim is submitted; and
sending a weekly follow-up reminder request to the insured employer until the employee is back to work with no restrictions or the employer requests no more follow-up reminders.

5. The method as in claim 4, further comprising sending a message to a worker's compensation agent or employee when the worker's compensation claim is submitted to a worker's compensation carrier.

6. The method as in claim 4, further comprising sending the insured employer a bi-monthly email after the employee is back to work until a claim is closed or the claim reserves have been removed.

7. The method as in claim 4, wherein the employee update request, employer claim update request, and decision time update request provide a link to a web form in a web application to enable corresponding update information to be submitted to the database for the worker's compensation claim.

8. The method as in claim 4, wherein the employee update request is sent in a short range time frame of less than 12 hours after the worker's compensation claim is submitted.

9. The method as in claim 4, wherein the employer update request is sent less than 48 hours after the worker's compensation claim is submitted.

10. The method as in claim 4, wherein the medium range time frame is less than 72 hours.

11. The method as in claim 4, wherein the employer claim update request includes a request to collect information using a web application about: whether the employee has returned to work, work type performed by the employee, whether a doctor has been contacted if the employee has not returned to work, and whether there is a reason for insurance agent contact.

12. The method as in claim 4, wherein the employee update request includes a request for the employer to follow-up and contact the employee about the employee's injury condition.

13. The method as in claim 4, wherein the decision time update request includes: a request to determine whether the employee has returned to work, why the employee has not returned to work, who contacted the doctor, an estimated date for return to work, and a reason to contact the agent.

14. The method as in claim 4, wherein the weekly email includes a request to collect information about: the employee's medical treatment, the employee's medical condition, who contacted the doctor if the employee has not returned to work, and any reason to contact the agent.

15. A system for communicating with employers in the worker's compensation process, the system comprising:
a server having a processor and memory;
a web server on the server to receive a worker's compensation claim;
a database located on the server to store the worker's compensation claim;
a submission module to submit the worker's compensation claim to a worker's compensation carrier and notify a worker's compensation agent and employer when the worker's compensation claim is submitted to a worker's compensation carrier;
a messaging module in the server to send: i) an employee update request to the insured employer less in a short range time frame after the worker's compensation claim has been submitted, ii) an employer claim update request to the insured employer in a medium range time frame after the worker's compensation claim has been submitted, iii) an employer claim update request to the insured employer in a medium range time frame after the worker's compensation claim has been submitted, and iv) a decision time update request to the insured employer in a medium range time frame after the worker's compensation claim is submitted; and
a web application on the web server to collect information for the messaging module.

16. The system as in claim 15, wherein the messaging module is configured to send a weekly follow-up reminder request to the insured employer until the employee is back to work with no restrictions or the employer requests not more follow-up reminders.

17. The system as in claim 15, wherein the employer claim update request includes a request to collect information using a web application about: whether the employee has returned to work, work type performed by the employee, whether a doctor has been contacted if the employee has not returned to work, and whether there is a reason for insurance agent contact.

18. The system as in claim 15, wherein the employee update request includes a request for the employer to follow-up and contact the employee about the employee's injury condition.

19. The system as in claim 15, wherein the decision time update request includes: a request to determine whether the employee has returned to work, why the employee has not returned to work, who contacted the doctor, an estimated date for return to work, and a reason to contact the agent.

20. The system as in claim 15, wherein the weekly email includes a request to collect information about: the employee's medical treatment, the employee's medical condition, who contacted the doctor if the employee has not returned to work, and any reason to contact the agent.

21. A system for communicating with employers in the worker's compensation process, the system comprising:
a server having a processor and memory;
a database located on the server to store the worker's compensation claim;
a web server on the server to receive a worker's compensation claim;
a daemon on the web server to receive requests for web pages from the web server and retrieve web pages from the database;
an alarming module in the daemon that checks worker's compensation claims in the database to determine when a request for worker's compensation claim information should be send out;
wherein the alarming module in the server sends requests to the employer at predefined intervals to collect information from the employer using a web form.

22. The system as in claim 21, wherein the requests are email messages containing a link to a web form request using a web application.

23. The system as in claim 22, wherein the web form requests can contain a request selected from the group comprising: i) an employee update request to the insured employer less in a short range time frame after the worker's compensation claim has been submitted, ii) an employer claim update request to the insured employer in a medium range time frame after the worker's compensation claim has been submitted, iii) an employer claim update request to the insured employer in a medium range time frame after the worker's compensation claim has been submitted, and iv) a decision time update request to the insured employer in a medium range time frame after the worker's compensation claim is submitted.

24. The system as in claim 22, wherein the daemon provides security services for each page accessed by web server.

25. A method for interacting with employers in a worker's compensation process, comprising:
under control of a processor and memory configured with executable instructions,
capturing an image on a mobile computing device related to a worker's compensation claim;
initiating a worker's compensation claim on a mobile device in response to capturing the image;
receiving a worker's compensation claim associated with the image at a server having a processor and a memory;
storing the worker's compensation claim in a database on the server;
submitting the worker's compensation claim from the server to a worker's compensation carrier's server;
sending an employee update request to an insured employer in a short range time frame after the worker's compensation claim has been submitted; and
sending an employer claim update request to the insured employer in a medium range time frame after the worker's compensation claim has been submitted;
sending a decision time update request to the insured employer in a medium range time frame after the worker's compensation claim is submitted; and
sending a weekly follow-up reminder request to the insured employer until the employee is back to work with no restrictions or the employer requests no more follow-up reminders.
